(19) United States
(12) Patent Application Publication
(10) Pub. No.: US 2015/0084828 A1
(43) Pub. Date: Mar. 26, 2015

(54) Flexible Antenna

(71) Applicant: Sinbon Electronics Company LTD., New Taipei City (TW)

(72) Inventor: Wei Sun, JiangSu (CN)

(73) Assignee: Sinbon Electronics Company LTD., New Taipei City (TW)

(21) Appl. No.: 14/140,087

(22) Filed: Dec. 24, 2013

(30) Foreign Application Priority Data
Sep. 23, 2013 (CN) 201320585807.7

(51) Int. Cl. H01Q 1/42

(52) U.S. Cl. CPC H01Q 1/427
USPC 343/872

(57) ABSTRACT

A flexible antenna includes a shell, an antenna, a flexible line, and a hollow unit. The flexible line is attached alongside the antenna and both the flexible line and the antenna are mounted in the shell. The hollow unit is connected with the shell, and is penetrated by the antenna. The flexible line has ductility and rigidity. The flexible line can be bent in any direction with the antenna because of the ductility of the flexible line. After the flexible line is bent, the flexible line can be fixed firmly because of the rigidity of the flexible line. A user can adjust a position of the antenna such that the antenna can receive wireless signals of good communication quality.

### BACKGROUND OF THE INVENTION

1. Field of the Invention

The present invention relates to an antenna, and more particularly, to a flexible antenna.

2. Description of the Related Art

Wireless communications are becoming increasingly popular. Pluralities of electronic devices are provided with wireless communications capabilities. An electronic device with the wireless communication capability has an antenna to communicate with other electronic devices or with a base station having an antenna. For example, the base station can receive a wireless signal from the electronic device or broadcast a wireless signal to the electronic device using the antenna.

A mounting position of the antenna on the base station would influence quality for receiving or broadcasting the wireless signals. A conventional antenna is pin-jointed with a case of the base station. Because of the pin jointed structure of the conventional antenna, the conventional antenna can only pivot on the case in one plane. When wireless signals cannot have good communication quality on positions in this one plane, the case of the base station should be moved and repositioned to another place for adjusting the conventional antenna such that the wireless signals can have good communication quality.

When the conventional antenna is set outdoors, the position of the antenna may be affected and impacted by winds and rain. The conventional antenna may be shifted to another position or bent toward another direction when it is hit by the wind and cannot be fixed firmly at its original position. The rain may enter the case of the base station, and an electronic circuit of the antenna in the case of the base station may be dampened by the rain.

It would therefore be desirable to provide improved antennas to overcome the aforementioned shortcomings.

### SUMMARY OF THE INVENTION

An objective of the present invention is to provide a flexible antenna that can be bent in any direction, and can be mounted firmly at a desired position after bending.

In order to achieve the foregoing objective, the present invention provides a flexible antenna comprising:
a shell having a front part and a back part;
an antenna having
   a front portion mounted in the front part of the shell;
   a signal portion; and
   a middle portion connected between the front portion and the signal portion, and mounted in the back part of the shell;
a flexible line mounted alongside the middle portion of the antenna and also mounted in the back part of the shell, and having
   a first front end and a first back end; and
a hollow unit penetrated by the antenna, and having
   a second front end connected with the back part of the shell; and
   a second back end.

The advantage of the present invention is that the flexible line has ductility and rigidity. The flexible line can be bent in any direction with the middle portion of the antenna such that the wireless signal communication has good quality. After the flexible line is bent, the flexible line can be mounted firmly because of the rigidity of the flexible line. The flexible line will not be forced to another position or direction by winds.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a case and a flexible antenna in accordance with a preferred embodiment of the present invention.

FIG. 2 is an exploded perspective view of the case and the flexible antenna of FIG. 1.

FIG. 3 is a cross sectional view of the case and the flexible antenna of FIG. 1.

FIG. 4 is a schematic view of the case and the flexible antenna of FIG. 1 after bending.

### DETAILED DESCRIPTION OF THE INVENTION

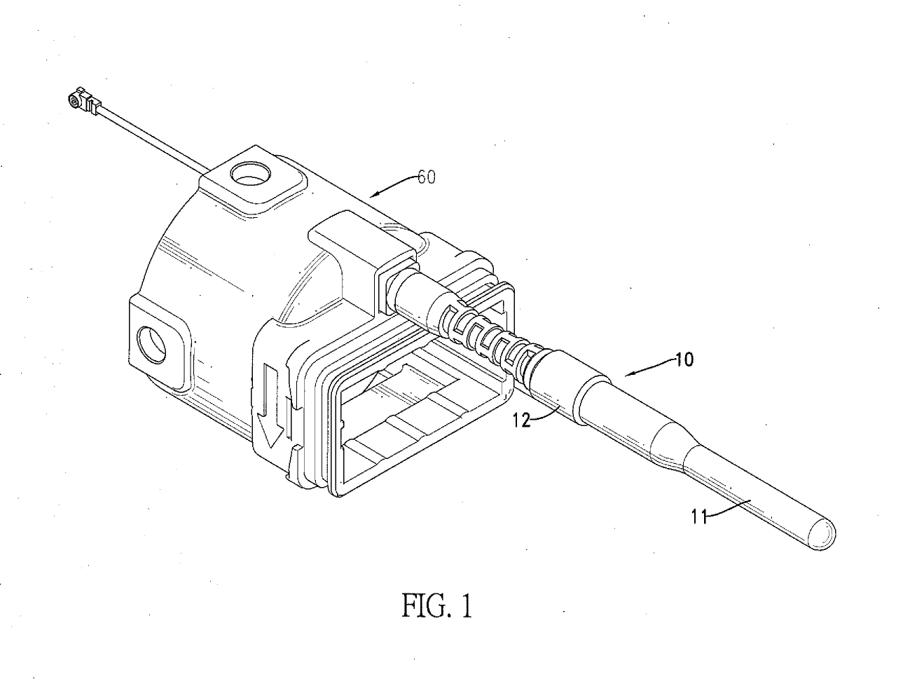

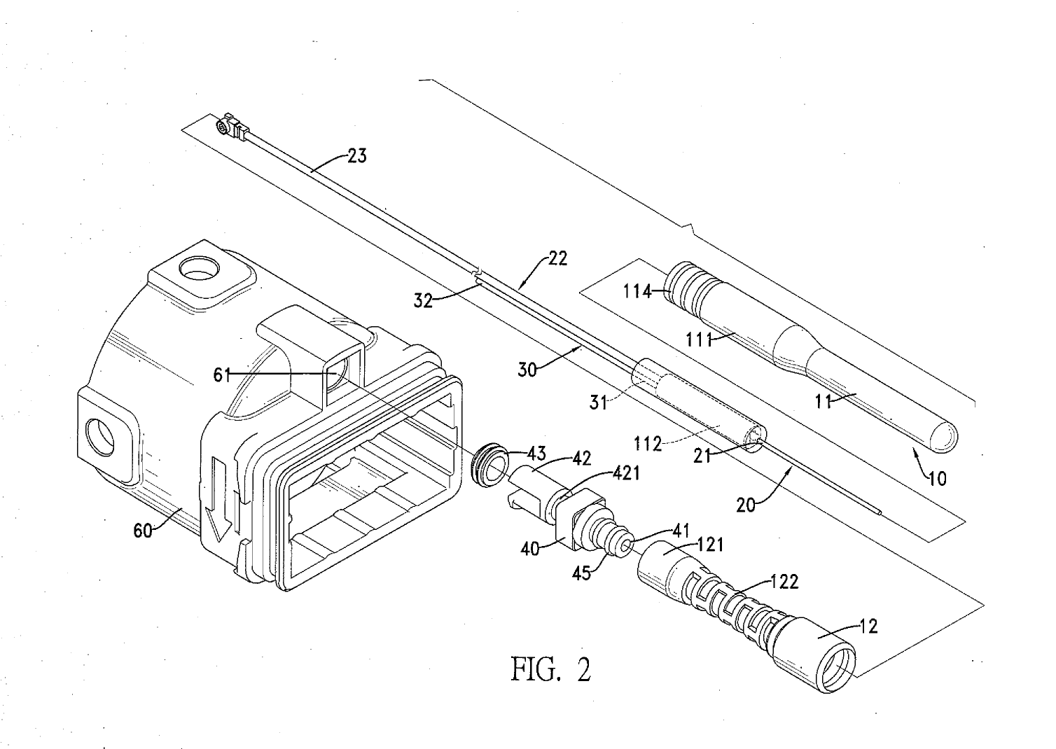

With reference to FIGS. 1 and 2, a flexible antenna of the present invention is adapted to a case 60, and comprises a shell 10, an antenna 20, a flexible line 30, and a hollow unit 40.

The shell 10 includes a front part 11 and a back part 12. The back part 12 is flexible, and preferably an outer diameter of the back part 12 is tapered off from two ends of the back part 12 toward a middle of the back part 12. The back part 12 has an outer wall and a plurality of transverse notches 122 formed in the outer wall that allow the shell 10 to be bent more easily. The front part 11 further includes a hollow stopper 112.

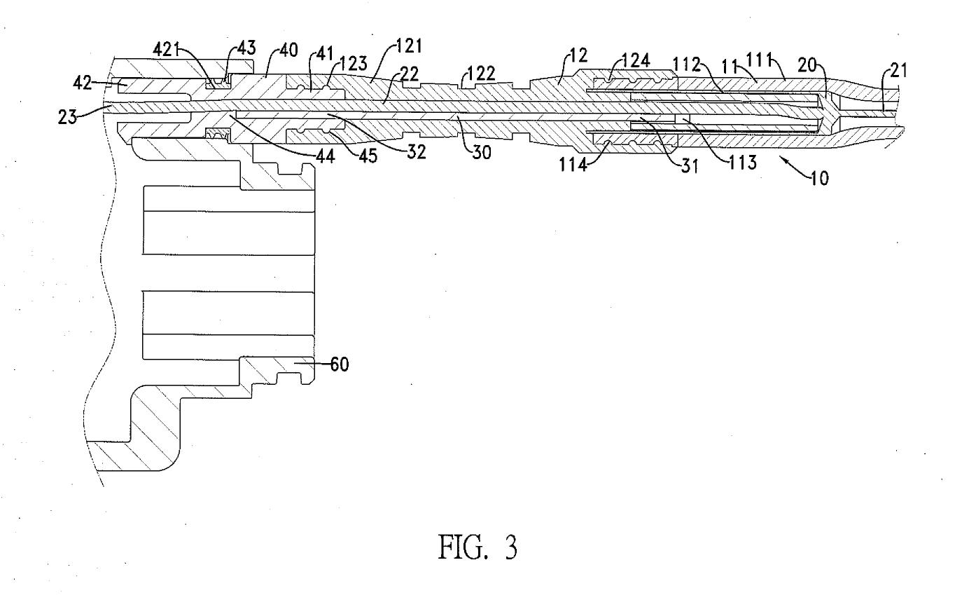

With reference to FIG. 3, the hollow stopper 112 is mounted in the front part 11 and has an inner wall and a first stopping part 113 formed on the inner wall.

In a preferred embodiment, the shell 10 is comprised of two separate elements, i.e. a front shell 111 and a back shell 121. At least one circular notch 114 is formed in an outer wall of one end of the front shell 111 that is connected with the back shell 121, and at least one circular rib 124 is formed on an inner wall of one end of the back shell 121 that is connected with the front shell 111 for engaging firmly with the at least one circular notch 114, or vice versa. In the preferred embodiment, the outer wall of the front shell 111 has three circular notches 114, and the inner wall of the back shell 121 has three circular ribs 124.

With reference to FIGS. 1 and 2, the antenna 20 includes a front portion 21, a middle portion 22, and a signal portion 23. The middle portion 22 of the antenna 20 is between the front portion 21 and the signal portion 23. The front portion 21 of the antenna 20 is mounted around the hollow stopper 112 and then held in the front part 11 of the shell 10. The middle portion 22 is mounted in the back part 12 of the shell 10. The signal portion 23 of the antenna 20 extending through the hollow unit 40 is located in the case 60.

With reference to FIG. 3, the flexible line 30 is mounted alongside the middle portion 22, and is also mounted in the back part 12 of the shell 10. The flexible line 30 has a first front end 31 and a first back end 32. The first front end 31 is mounted in the hollow stopper 112, and is limited in position by the first stopping part 113 of the hollow stopper 112.

The flexible line 30 can be bent in any direction with the middle portion 22 of the antenna 20 for receiving wireless signals of good communication quality. After the flexible line 30 is bent, the flexible line 30 can be mounted firmly because of its own rigidity. The flexible line 30 will not be further forced to any other position or direction by winds. In the preferred embodiment, the flexible line 30 is a metal wire, and preferably is a copper wire or an aluminum wire.

The hollow unit 40 has a second front end 41 and a second back end 42. The second front end 41 is connected with the back part 12 of the shell 10 and has an outer wall. A circular notch 421 is formed in the outer wall of the second front end, and a waterproof ring 43 is mounted around the circular notch 421. The case 60 has a coupling hole 61. When the second back end 42 is inserted into the coupling hole 61 of the case 60, the waterproof ring 43 is tightly pressed between an outer wall of the circular notch 421 and an inner wall of the coupling hole 61 for preventing water from entering the case 60. The hollow unit 40 is penetrated by the signal portion 23 of the antenna 20.

The hollow unit 40 has an inner wall and a second stopping part 44 formed on the inner wall of the hollow unit 40. The first back end 32 is mounted in the second front end 41, and is limited in position by the second stopping part 44.

A least one circular notch 123 is formed in an inner wall of one of the ends of the back part 12 that is connected with the second front end 41, and at least one circular rib 45 is formed on an outer wall of the second front end 41 for engaging firmly with the at least one circular notch 123, or vice versa. In the preferred embodiment, the inner wall of the back part 12 has three circular notches 123, and the outer wall of the second front end 41 has three circular ribs 45.

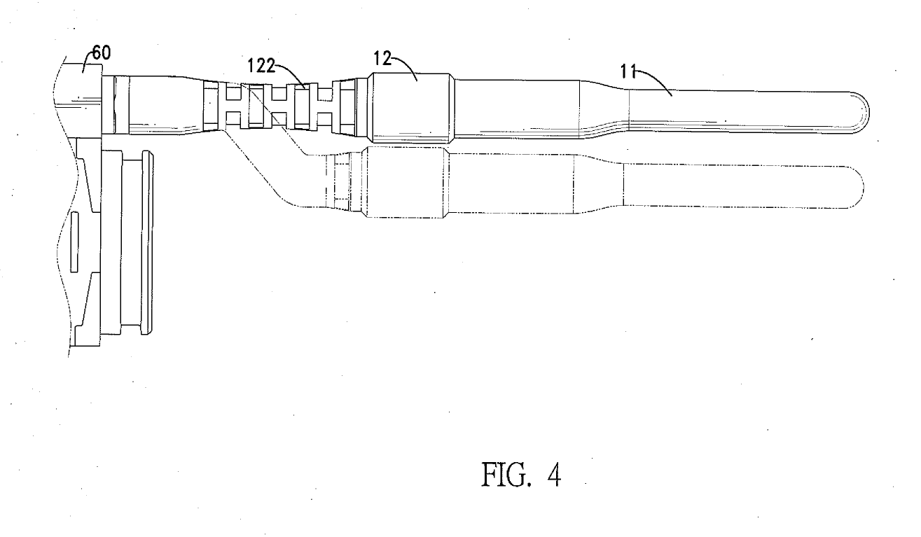

With reference to FIGS. 3 and 4, the back part 12 of the shell 10 acts as a bendable segment of the flexible antenna. The back part 12 covers the middle portion 22 and the flexible line 30. When the flexible antenna is bent, the flexible line 30 can be bent toward a proper direction with the middle portion 22 so that the antenna 20 can receive the wireless signals of good communication quality. Because the outer diameter of the back part 12 is tapered off from the two ends of the back part 12 toward the middle of the back part 12, and the outer wall of the back part 12 has the transverse notches 122, the flexible line 30 and the back part 12 of the shell 10 are bent more easily.

Even when the flexible antenna is set outdoors, the antenna 10 will not be forcefully moved by winds away from its original position, and the antenna 10 will not be dampened by rain. The flexible line 30 has ductility and rigidity. The flexible line 30 can be bent in any direction with the middle portion 22 so that the antenna 20 can receive the wireless signals of good communication quality. After the flexible line 30 is bent, the flexible line 30 can be mounted firmly because of its own rigidity. The flexible line 30 cannot be moved to another position or direction by the winds.

Furthermore, the front shell 111, the back shell 121, and the hollow unit 40 are connected with each other tightly, and therefore water cannot enter the shell 10 and the case 60. The waterproof ring 43 is tightly pressed between the outer wall of the circular notch 421 and the inner wall of the coupling hole 61 for preventing water from entering the case 60. In the preferred embodiment, the front shell 111, the back shell 121, and the hollow unit 40 are formed by injection molding.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A flexible antenna comprising:
a shell having a front part and a back part;
an antenna having
a front portion mounted in the front part of the shell;
a signal portion; and
a middle portion connected between the front portion and the signal portion, and mounted in the back part of the shell;
a flexible line mounted alongside the middle portion of the antenna and also mounted in the back part of the shell, and having
a first front end and a first back end; and
a hollow unit penetrated by the antenna, and having
a second front end connected with the back part of the shell; and
a second back end.

2. The flexible antenna as claimed in claim 1, wherein the shell includes a hollow stopper mounted in the front part, and the hollow stopper is penetrated by the antenna; and
the first front end is mounted in the hollow stopper.

3. The flexible antenna as claimed in claim 2, wherein the hollow stopper has an inner wall and a first stopping part formed on the inner wall of the hollow stopper; and
the first front end is limited in position by the first stopping part.

4. The flexible antenna as claimed in claim 1, wherein the back part has an outer diameter; and
the outer diameter of the back part is tapered off from two ends of the back part toward a middle of the back part.

5. The flexible antenna as claimed in claim 1, wherein the back part has an outer wall and a plurality of transverse notches formed in the outer wall of the back part.

6. The flexible antenna as claimed in claim 1, wherein the hollow unit has an inner wall and a second stopping part formed on the inner wall of the hollow unit.

7. The flexible antenna as claimed in claim 1, wherein the second back end has an outer wall and a circular notch formed in the outer wall of the second back end; and
the hollow unit has a waterproof ring, and the waterproof ring is mounted around the circular notch.

8. The flexible antenna as claimed in claim 1, wherein the hollow unit is formed by injection molding.

9. The flexible antenna as claimed in claim 1, wherein the shell is formed by injection molding.

10. The flexible antenna as claimed in claim 1, wherein the flexible line is a metal wire.
